(19) United States
(12) Patent Application Publication
(10) Pub. No.: US 2022/0315503 A1
(43) Pub. Date: Oct. 6, 2022

(54) METHODS FOR PRODUCING TREATED MANURE

(71) Applicant: COMMONWEALTH SCIENTIFIC AND INDUSTRIAL RESEARCH ORGANISATION, Acton (AU)

(72) Inventor: Robert Douglas KINLEY, Acton, Australian Capital Territory (AU)

(21) Appl. No.: 17/633,795

(22) PCT Filed: Aug. 10, 2020
(86) PCT No.: PCT/AU2020/050829

§ 371 Date: Feb. 8, 2022

(30) Foreign Application Priority Data
Aug. 8, 2019 (AU) 2019902841

(51) Int. Cl. C05F 17/80; C05F 3/06; C05F 3/00; C05F 17/20; C05F 17/10

(52) U.S. Cl. CPC C05F 17/80; C05F 3/06; C05F 3/00; C05F 17/20; C05F 17/15

(57) ABSTRACT

The present invention relates to a method of and additives for producing treated animal manure.

### FIELD OF THE INVENTION

The present invention relates to methods, systems and compositions for the treatment of animal manure.

### BACKGROUND OF THE INVENTION

Methane (CH₄) in the atmosphere is a potent greenhouse gas (GHG) with an IPCC Fifth Assessment Report (AR5) global warming potential 28 times that of carbon dioxide (CO₂) (IPCC 2014). Between 2000 and 2009, agriculture and waste management accounted for 62% of global anthropogenic CH₄ emissions.

Most of the CH₄ emission from manure is produced under anaerobic conditions, for example during storage, with diminishing methane release following land application of manure.

Methods to minimize the production of GHGs from manure focus on altering storage conditions (such as application to land, adjusting storage temperatures, and aeration), or importantly, capturing and transforming any CH₄ that is produced. The production and utilization of methane containing biogas by anaerobic digestion of organic wastes such as an animal manure is an emerging alternative renewable energy technology.

Biogas is envisioned as a key element in emerging renewable energy strategies in many parts of the world, and is incentivized by governments setting targets for renewable energy use. Biogas mainly contains CH₄ (50-75%) and CO₂ (25-50%).

Much work has been undertaken to increase CH₄ content in biogas to higher than 90%, to not only increase the heating value, but also reduce corrosion caused by acid gas and therefore extend the biogas utilization as a renewable energy source.

Common methods of increasing methane content in biogas include water washing, pressure swing adsorption, polyglycol adsorption and chemical treatment, which aim to remove CO₂ from the biogas. The costs of the above methods are relatively high since they need either high pressure or addition of chemicals. When removing CO₂ from biogas, small amounts of CH₄ are also removed, which will possibly contribute to fugitive greenhouse gas emissions.

There remains a need for reducing the effects and extent of GHG emissions from manure into the environment.

### SUMMARY OF THE INVENTION

In one aspect, the present invention provides a method for reducing methane production from anaerobic degradation of animal manure comprising the step of contacting said manure with an effective amount of biomass comprising bromoform.

In one embodiment, the biomass comprising bromoform is a biomass of red marine macroalgae.

In another embodiment, the red marine macroalgae is an Asparagopsis species or a Bonnemaisonia species.

In a further embodiment, the red marine macroalgae is selected from the group consisting of Asparagopsis taxiformis, Bonnemaisonia hamifera and Bonnemaisonia asparagoides.

In another embodiment, the animal manure is a ruminant animal manure or a monogastric animal manure.

In another embodiment, the effective amount of biomass is contacted with said animal manure at a level of at least 0.1% of organic matter of the manure.

In another embodiment, the effective amount of biomass is contacted with said animal manure at a level of at least 0.2% of organic matter of the manure.

In another embodiment, the effective amount of biomass is contacted with said animal manure at a level of at least 0.4% of organic matter of the manure.

In another embodiment, the effective amount of biomass is contacted with said animal manure at a level of at least 0.8% of organic matter of the manure.

In one embodiment, the animal manure is from an animal selected from the members of the Suina, Ruminantia and Tylopoda suborders.

In another embodiment, said animal is a swine, cattle or sheep.

In another aspect, the present invention provides an additive for reducing methane production from anaerobic degradation of animal manure, said additive comprising an effective amount of a biomass comprising bromoform.

In one embodiment, the biomass comprising bromoform is a biomass of red marine macroalgae.

In another embodiment, the red marine macroalgae is an Asparagopsis species or a Bonnemaisonia species.

In a further embodiment, the Asparagopsis species is Asparagopsis taxiformis or Asparagopsis armata.

In another embodiment, the animal manure is a ruminant animal manure or a monogastric animal manure.

In another embodiment, the effective amount of biomass is formulated for contact with said animal manure at a level of at least 0.1% of organic matter of the manure.

In another embodiment, the effective amount of biomass is formulated for contact with said animal manure at a level of at least 0.2% of organic matter of the manure.

In another embodiment, the effective amount of biomass is formulated for contact with said animal manure at a level of at least 0.4% of organic matter of the manure.

In another embodiment, the effective amount of biomass is formulated for contact with said animal manure at a level of at least 0.8% of organic matter of the manure.

In another embodiment, the animal is selected from the members of the Suina, Ruminantia and Tylopoda suborders.

In another embodiment, the animal is a swine, cattle or sheep.

In another embodiment, the present invention provides a method for reducing methane production from anaerobic degradation of animal manure comprising the step of contacting said manure with an effective amount of an additive as described herein.

In another aspect, the present invention provides a method for anaerobic degradation of animal manure comprising the step of contacting said manure with an effective amount of biomass comprising bromoform. In one embodiment, the present invention provides a method as described herein comprising initiating anaerobic degradation of animal manure in a system comprising a reactor vessel.

In another aspect, the present invention provides a system when used for a method described herein.

### BRIEF DESCRIPTION OF THE DRAWINGS

FIG. 1 shows the amount of methane (CH₄) produced (as % of headspace gas) by manure in the presence of Asparagopsis at different levels of inclusion (as a % of organic matter; ‘OM’).

FIG. 2 shows example biomass of Asparagopsis taxiformis and Asparagopsis armata contain bromoform. Biomass of Asparagopsis taxiformis gametophyte stage collected from a site near Humpy Island, Keppel Bay contained approximately 6.55+/−1.86 mg/g dry weight bromoform (“Keppels 2016”), and biomass of Asparagopsis armata contained an average of approximately 3.16+/−90 mg/g bromoform (“A. armata average”), a halogenated metabolite. Depths in meters is shown for collection depths of free floating Asparagopsis armata tetrasporporophyte stage.

### DETAILED DESCRIPTION

The present inventors have examined the effect of bromoform containing biomass on ruminal fermentation in vitro using rumen fluid, or administration to animals in feed, but, prior to the present invention, it was not known whether biomass containing bromoform can mitigate methane production in circumstances other than via ruminal fermentation.

Following ruminal fermentation where methane is produced in the rumen and released by belching, the contents move to the omasum, where water and nutrients are absorbed. The contents then move to the abomasum which has a pH of 2-3 and which digests protein from feed and ruminal microbiota. Once the feed has passed through acid-based digestion in the abomasum, it enters the small intestine where the contents are mixed with pancreatic secretions, to enzymatically break down and absorb nutrients. Finally, the contents pass through the large intestine which absorbs water and minerals, and colonic fermentation occurs.

Accordingly, the composition of manure is physically and structurally distinct from the composition of rumen fluid. It is also known that the rumen and manure microbiomes differ significantly.

In vitro studies using rumen fluid have demonstrated that the production of CH₄ is significantly affected by synthetic halomethanes when these synthetic compounds are added to rumen fluid. For example, bromoform and dibromochloromethane when added to rumen fluid inhibit the production of CH₄ compared to control when added to rumen fluid at a concentration of 1 μM, and also at concentrations ≥5 μM (Machado, L., Magnusson, M., Paul, N. A. et al. J Appl Phycol (2016) 28: 3117).

However, previous work has demonstrated that the effects of such secondary metabolites in rumen fluid are variable and contradictory due to the differences in extracts/compositions comprising such compounds, doses of compounds, and the influence type and quality of basal diet.

Bromoform is volatile and has physical properties (including its volatility) which make impractical its use in vivo or in vitro. The use of synthetic bromoform on ruminal fermentation in vivo has not been studied. Furthermore, exposure to high levels of concentrated bromoform are considered to be hazardous to animals.

Accordingly, bromoform and chemically related compounds (e.g. bromochloromethane) as synthetic/purified chemicals are unsafe and disallowed for human and animal applications, including the inhibition of methanogenesis in ruminant animals.

It has been demonstrated that inhibitors that reduce enteric CH₄ when administered to animals in animal feed are unable to reduce CH₄ yield when added to manure. For example, an enteric CH₄ inhibitor, 3-nitrooxypropanol (3NOP), administered in animal feed reduced CH₄ emission from beef cattle by 59% and the reduction of DNA copy number of methanogens. Other studies with 3NOP have reported reductions in CH₄ emissions ranging from 24% in sheep and up to 60% in dairy cattle. While 3NOP is effective in reducing enteric CH₄ production when administered to animals in feed, it does not decrease CH₄ yield when added to animal manure. For example, Nkemka et al. in 2019, Water Science and Technology, 80.3, demonstrated that spiking feces with 200 mg 3NOP kg⁻¹ dry matter resulted in no significant difference in the overall CH₄ yield. This study also demonstrated that inclusion of inhibitors such as 3NOP in animal diets had no significant downstream effect on CH₄ emissions of the feces, and therefore may be useful as an enteric CH₄ inhibitor—inhibiting methane only under enteric conditions—with no residual effect on anaerobic digestion. It is clear from the field that inhibitors that decrease methane production in in vitro studies using rumen fluid and when administered to animals in feed such as 3NOP do not necessarily inhibit methane yield when contacted with animal manure.

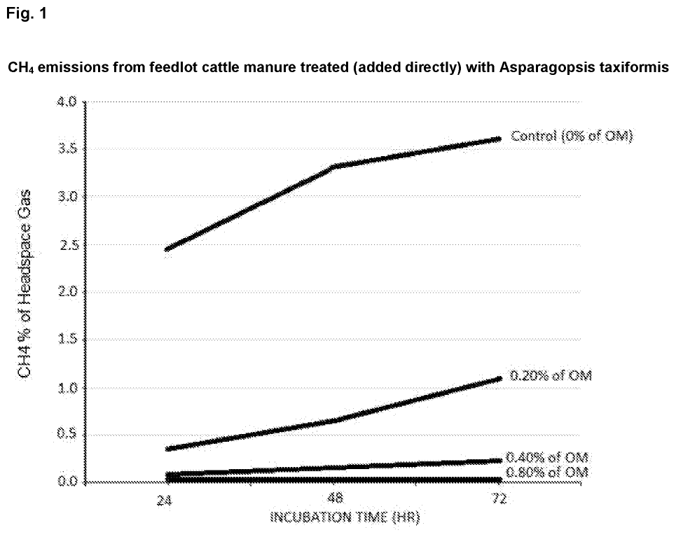

The present invention is based in part on the surprising discovery that bromoform containing biomass, such as a biomass of Asparagopsis, when contacted with animal manure can reduce methane production from anaerobic digestion of the animal manure in vitro, without passing through the digestive system of the animal (e.g. not having been physically chewed/ruminated, entered the rumen and contacted the rumen contents, or passed through the rumen). For example, FIG. 1 shows a reduction of methane produced in vitro from anaerobic fermentation of manure contacted with red marine macroalgae. Accordingly, in one embodiment the present invention provides a method for reducing methane production from anaerobic degradation of animal manure comprising the step of contacting said manure with an effective amount of biomass comprising bromoform.

In contrast to the rumen, a nutrient rich system in favour of the growth of microbes that can contribute to anaerobic fermentation, manure has less available nutrients, water, minerals and energy and is exposed to aerobic conditions, usually at a temperature cooler than the body temperature of the animal.

As used herein, the term “reducing” includes the reduction of amount of substance in comparison with a reference. For example, the reduction in the amount of total gas and/or methane produced by an animal manure contacted with a biomass comprising bromoform, a biomass of red marine macroalgae or an additive according to the present invention, relative to an animal manure not contacted with a biomass comprising bromoform, a biomass of red marine macroalgae or additive according to the present invention. The reduction can be measured in vitro, for example with a system that models anaerobic fermentation. It is within the knowledge and skill of those trained in the art to assess methane and/or total gas production from manure.

As used herein, the term “reducing methane production” refers to the reduction of methane produced, for example, the amount of methane produced from manure over a period of time. The term includes the specific volume of methane generated as a result of anaerobic fermentation, for example, from stored manure, in a biodigester, or in the systems described herein. Anaerobic fermentation of manure gives rise to production of methane. The present invention aims to reduce this process, such as to reduce the total amount of methane produced. It is within the knowledge and skill of those trained in the art to assess methane production.

As used herein, the term “reducing methanogenesis” refers to the reduction of methane produced, for example, the amount of methane produced from manure over a period of time, by anaerobic methanogens in the manure. The term includes the specific volume of methane generated as a result of methanogenesis, for example, from stored manure, in a biodigester or in the systems described herein. Methanogenesis in manure gives rise to production of methane. The present invention aims to reduce this process, such as to reduce the total amount of methane produced. It is within the knowledge and skill of those trained in the art to assess methane production.

A biomass comprising bromoform may be used for reducing total gas produced from manure.

As used herein, the term “reducing total gas production” refers to the reduction of the total amount of gas produced, for example the amount of total gas produced from manure over a period of time. The term includes the collective volume of all gasses generated as a result of anaerobic fermentation, for example, from stored manure or in the systems described herein. Fermentation of manure gives rise to production of gas including methane. The present invention aims to reduce this process, such as to reduce the total amount of gas produced. It is within the knowledge and skill of those trained in the art to assess total gas production.

As used herein the term “anaerobic degradation” refers to anaerobic fermentation in vitro, for example, in stored manure or manure present in a digester, or a system described herein. Anaerobic fermentation results in the production of biogas which includes methane and carbon dioxide.

Methane formation is a consequence of anaerobic fermentation of feed organic matter (OM) by a microbial consortium that produces substrate CO₂ and hydrogen in a reduction pathway used by methanogens. The mode of action of low molecular weight halomethanes is proposed to be through enzymatic inhibition by reaction with reduced vitamin B₁₂ which chemically resembles coenzyme F430—a cofactor proposed to be needed for methanogenesis, and this reaction may reduce the efficiency of the cobamide-dependent methyl transferase step required for methanogenesis.

Importantly, 3-nitrooxypropanol (3NOP), a compound designed to inhibit the activity of methyl coenzyme-M reductase, the enzyme responsible for microbial formation of CH₄, decreases enteric CH₄ emissions from lactating dairy cows when administered in animal feed, but does not decrease total methane yields when added to animal manure. Furthermore, work with inhibitors in vivo has demonstrated that the rumen microbiota can become resistant to inhibitors such as BES, as a consequence of microbial resistance, it has been proposed that some inhibitors of methane production will not have a significant or long-term role in reducing methane (Mathison et al. Journal of Applied Animal Research, 14:1, 1-28).

In addition to adaptation of microbial ecosystems to inhibitors (e.g. resistance to inhibitors), toxicity to animals and the susceptibility of inhibitors to anaerobic degradation has led to limited use in animal feed. For example, reductive dehalogenation of brominated organic compounds occurs through microbial activity and also under sterile anaerobic conditions [Bouwer et al., Environ. Sci. Tech., 15, 596-599, 1981, Bouwer and McCarthy, Appl. Environ. Microbiol., 95, 1286-129; Goodwin et al., Environ. Sci. Technol., 31, 3188-3192].

The compound bromoform has been demonstrated to be readily degraded under anerobic conditions. For example, Bromoform, at initial concentrations ranging from 132 to 177 μg/L, underwent >99% reduction in a continuous-flow biofilm column seeded with primary settled sewage with 1.5 hours packed-bed detention time (Cobb and Bouwer Environ. Sci. Technol. 25: 1068-1074).

Importantly, the present inventors have demonstrated that biomass comprising the volatile halomethane bromoform can be contacted with animal manure and, surprisingly, cause effective inhibition of methanogenesis.

Importantly, the biomass is in a form in which the bromoform (and one or more of dibromocholoromethane, bromochloroacetic acid, dibromoacetic acid, and/or dichloromethane) remain effective, allowing inhibition or methanogenesis in anaerobic conditions.

In one embodiment the present invention provides a method for reducing methanogenesis in an animal manure comprising the step of contacting said manure with an effective amount of biomass comprising bromoform.

Accordingly, in one embodiment the methods of the present invention are performed under conditions where methanogenesis by methanogens can occur, for example, anaerobic conditions.

In one embodiment the methods described herein are performed at a temperature permissive of methanogenesis, such as a psychrophilic (15 to 25° C.), mesophilic (30 to 38° C.), and thermophilic (50 to 60° C.), temperature. These temperatures/temperature ranges facilitate the growth of specific microbes. Without wishing to be bound by theory, thermophilic systems are more sensitive to environmental changes, such as temperature fluctuations and chemical concentrations produced during anaerobic degradation, because the number of functional microorganism species that thrive at this temperature is considerably less than those that survive at lower temperatures. Below 15° C., in usual systems, the production of biogas is greatly reduced and CO₂ becomes the dominant product of anaerobic digestion; therefore, anaerobic digestion systems are usually not recommended for geographic locations with average temperatures below this threshold without supplemental heat and temperature control.

In another embodiment, the present invention provides a method as described herein wherein the method provides contacting manure containing anaerobic methanogenic organisms with an effective amount of biomass comprising bromoform. In one embodiment of the methods and systems described herein, an anaerobic inoculum comprising anaerobic methanogenic organisms is added to the manure or to the system to effect anaerobic degradation.

In one aspect the present invention relates to a method of manufacturing treated manure, said method comprising:
a. providing an animal manure and initiating an anaerobic degradation process in a system (e.g. bioreactor)
b. contacting the animal manure with an effective amount of biomass comprising bromoform under anaerobic conditions; and
c. collecting the treated manure.

As is discussed in further detail below, biomass comprising bromoform may be contacted with an animal manure (e.g. by adding a biomass comprising bromoform) at a regular interval. Accordingly, in one aspect the present invention relates to a method of manufacturing treated manure, said method comprising:
a. providing an animal manure and initiating an anaerobic degradation process in a system (e.g. bioreactor)
b. contacting the animal manure with an effective amount of biomass comprising bromoform under anaerobic conditions at a regular interval; and
c. collecting the treated manure.

In one aspect the present invention relates to a method of manufacturing treated manure, said method comprising:
a. providing an animal manure and initiating an anaerobic degradation process in a system (e.g. bioreactor), by adding an anaerobic inoculum
b. contacting the animal manure with an effective amount of biomass comprising bromoform under anaerobic conditions; and
c. collecting the treated manure.

The treated manure, e.g. effluent of a digester, also referred to as digestate, typically contains most of the nutrients found in the manure, and is used interchangeably with the terms sludge and liquor.

As used herein the term “animal manure” or “an animal manure” refers to faecal matter or manure produced as a by-product of an animal's digestion of food which has exited the animal, for example manure from cattle, swine, sheep, horses, mink, chicken or human faecal matter which may be in the form of sewage sludge or septage. The term includes compositions comprising faecal matter or manure produced as a by-product of an animal's digestion of food. Preferably the manure is a livestock manure, such as ruminant animal manure, or a swine manure. In one embodiment the manure is manure from one species of animal. In another embodiment, the manure is manure from two or more species of animal (e.g. ‘co-digestion’ or ‘co-degradation’). For example, co-degradation of ruminant animal manure with poultry manure.

Ruminant animals use physical chewing, and re-chewing of food that has entered the rumen, to break down the food and rumen contents, and then the fluid contents and undegraded feed solids of the rumen pass through the remainder of the digestive system of the ruminant animal, where absorption of nutrients, water, minerals and energy occurs.

Examples of ruminants are listed below.

The biomass comprising bromoform can be used for methods and additives for treating manure from domesticated livestock such as swine, cattle, goats, sheep and llamas. The present invention is particularly useful for treating manure of swine, cattle and sheep. Therefore, in one embodiment, said animal is selected from the members of the Suina, Ruminantia and Tylopoda suborders. In another embodiment, said ruminant animal is swine, cattle or sheep. In a further embodiment, animal is a swine or cattle.

Importantly, the inventors have shown that red marine macroalgae possess the property of inhibiting methane production when contacted with manure from a ruminant animal.

Accordingly, in one embodiment, the present invention provides methods and compositions as described herein, wherein the animal manure is a ruminant animal manure.

A biomass comprising bromoform may be also used for reducing total gas produced from manure of a monogastric animal. Accordingly, in one embodiment, the present invention provides methods and compositions as described herein, wherein the animal manure is a monogastric animal manure.

A monogastric animal is an animal with a single chambered stomach, such as a swine (e.g. a pig).

By “contact” and “contacting”, is meant the action of introducing a biomass comprising bromoform or an additive according to the invention directly or indirectly into or onto an animal manure. For example, contacting may be performed by mixing the biomass comprising bromoform or an additive according to the invention with an animal manure, or adding a biomass comprising bromoform or an additive according to the invention (e.g. spraying) onto the surface of an animal manure, adding the biomass comprising bromoform or an additive according to the invention into a biodigester or manure storage or any other means to bring the biomass comprising bromoform or an additive according to the invention into contact with an animal manure. The term includes placing the biomass comprising bromoform in sufficiently close proximity with the animal manure to enable the biomass comprising bromoform to alter methane production from the animal manure (e.g. act on the manure).

Bromoform (CHBr₃, tribromomethane) is a halomethane and has been shown to inhibit enzymatic activities by binding to vitamin B12, which chemically resembles coenzyme F430—a cofactor needed for methanogenesis. Prior to the present invention, it was not known if volatile secondary metabolites such as bromoform derived from Asparagopsis could complex with coenzyme F430 when added to an animal manure, nor whether a bromoform containing biomass could allow complexing of bromoform with coenzyme F430 when added to an animal manure, let alone inhibit methanogenesis.

As used herein, a “biomass comprising bromoform” refers to a mass of biological material, e.g. material prepared from a biological source, and includes biological or ‘organic’ sources of bromoform, for example biomass of red marine macroalgae such as an Asparagopsis species, or a Bonnemaisonia species which accumulate bromoform, or biomass of an organism engineered to produce and/or accumulate bromoform.

In one embodiment, the biomass comprising bromoform is at least one species of red marine macroalgae selected from a species of belonging the five genera of red seaweed in the family Bonnemaisoniaceae (for example, Asparagopsis, Bonnemaisonia, Delisea, Ptilonia, Leptophyllis and Pleuroblepharidella).

Without wishing to be bound by theory, the six genera of red seaweed in the family Bonnemaisoniaceae (for example Asparagopsis, Bonnemaisonia, Delisea, Ptilonia, Leptophyllis and Pleuroblepharidella), produce and store bioactive halogenated natural products. These secondary metabolites function as natural defenses against predation, fouling organisms and microorganisms, and competition among species.

In one embodiment, the species of red marine macroalgae is an Asparagopsis species.

Asparagopsis has a heteromorphic life history with two free-living life history stages—a gametophyte (large foliose form) and a sporophyte (or tetrasporophyte—smaller, filamentous form). Historically, the tetrasporophyte was recognised as a separate genus (Falkenbergia). Therefore, the term “Asparagopsis” as used herein refers to the genus Asparagopsis, and other taxonomic classifications now known to belong to the genus Asparagopsis.

There are two recognised species of Asparagopsis, one tropical/sub-tropical (Asparagopsis taxiformis) and one temperate (Asparagopsis armata) and present throughout the world.

A. taxiformis has been shown to contain bromoform, dibromocholoromethane, bromochloroacetic acid, dibromoacetic acid, and dichloromethane, with bromoform being the most abundant natural product in the biomass of Asparagopsis (1723 μg g-1 dry weight [DW] biomass), followed by dibromochloromethane (15.8 μg g-1 DW), bromochloroacetic acid (9.8 μg g-1 DW) and dibromoacetic acid (0.9 μg g-1 DW). Bromoform, dibromoacetic acid, dibromochloromethane and bromochloroacetic acid are produced and stored in specialised gland cells from where they are released onto the surface functioning as a natural defence against herbivores.

Prior to the present invention, it was not known whether volatile compounds such as bromoform present in the form of a biomass could function to inhibit methanogenesis in vitro (e.g. not in rumen fluid or in , without passing through the digestive system of the animal (e.g. not having been physically chewed/ruminated, entered the rumen and contacted the rumen contents, or passed through the rumen).

For example, prior to the present invention, it was not known whether secondary metabolites such as bromoform accumulated within gland cells of Asparagopsis and Bonnemaisonia could function to inhibit methanogenesis in vitro without passing through the digestive system of the animal (e.g. not having been physically chewed/ruminated, entered the rumen and contacted the rumen contents, or passed through the rumen) or when not delivered as fresh unprocessed biomass. It was also known that inhibitors, such as 3NOP, that work enterically do not work when added to manure.

Without wishing to be bound by theory, the present inventors propose volatile secondary metabolites such as bromoform are present in sufficient quantities in red algal (e.g. Asparagopsis spp. and Bonnemaisonia spp.) biomass to reduce methane production from ruminal fermentation in vitro, and surprisingly are bioavailable to inhibit methanogenesis without the biomass passing through the digestive system of the animal (e.g. not having been physically chewed/ruminated, entered the rumen and contacted the rumen contents, or passed through the rumen), and importantly, when not present in in vivo circumstances whereby volatile secondary metabolites released are released into the animal, nor present in a nutrient rich in vivo environment supportive of anaerobic fermentation.

Therefore, in one embodiment, the at least one species of red marine macroalgae is a species of the genus Asparagopsis selected from:
a. Asparagopsis armata
b. Asparagopsis taxiformis

In one embodiment, the at least one species of red marine macroalgae is a species of the genus Bonnemaisonia.

Therefore, in one embodiment, the at least one species of red marine macroalgae is a species of the genus Bonnemaisonia selected from:
a. Bonnemaisonia hamifera
b. Bonnemaisonia asparagoides.

In another embodiment, the biomass comprising bromoform is an organism capable of synthesizing and/or accumulating secondary metabolites such as bromoform. For example, an organism into which algal genes required for bromoform production have been introduced and which is capable of accumulating secondary metabolites such as bromoform at levels to allow in vitro inhibition of methanogenesis.

An “effective amount” of the biomass comprising bromoform may be determined by the methods described herein, including the in vitro dose-response studies described herein. For example, the present inventors have demonstrated that methane production/anaerobic fermentation in vitro can be used to examine the effect of amounts of the biomass comprising bromoform on levels of methane production. Therefore, anaerobic fermentation in vitro can be used to characterize doses of the biomass comprising bromoform that may be an effective amount sufficient to allow improvement, e.g. reduction in the amount of methane production in comparison with a reference or control or reduction in the amount of total gas produced in comparison with a reference or control.

For example, an effective amount of the at least one species of red marine macroalgae may be determined by the methods described herein, including the in vitro dose-response studies described herein. For example, the present inventors have demonstrated that methane production/anaerobic fermentation of manure in vitro can be used to examine the effect of amounts of the at least one species of red marine macroalgae on levels of methane production. Therefore, anaerobic fermentation in vitro can be used to characterize doses of the at least one species of red marine macroalgae that may be an effective amount sufficient to allow improvement, e.g. reduction in the amount of methane production in comparison with a reference or control or reduction in the amount of total gas produced in comparison with a reference or control.

For example an effective amount includes a quantity of biomass of red marine macroalgae sufficient to allow improvement, e.g. reduction in the amount of methane production in comparison with a reference or control, and/or reduction in the amount of total gas produced in comparison with a reference or control.

Without wishing to be bound by theory, the manure microbiota can maintain functional capacity for fermentation of the organic matter in manure, but at reduced capacity.

Accordingly, given the significant effects of bromoform containing biomass described herein, in one embodiment the bromoform containing biomass (e.g. a biomass comprising at least one species of red marine macroalgae) is preferably contacted with an animal manure in a form that results in the effects described herein (e.g. to reduce CH₄ output) without decreasing the quality of the manure.

Accordingly, given the significant effects of bromoform containing biomass described herein, in one embodiment the bromoform containing biomass (e.g. a biomass comprising at least one species of red marine macroalgae) is preferably contacted with an animal manure in a form that results in the effects described herein (e.g. to reduce CH₄ output) and maintains the quality of the manure.

Without wishing to be bound by theory, decreasing CH₄ emissions from manure will decrease the loss of organic carbon as CH₄ from the animal manure. Accordingly, in one embodiment the levels of organic carbon in the animal manure are maintained. In another embodiment the levels of organic carbon in the animal manure are improved compared. In another embodiment the levels of organic carbon in the animal manure are improved compared to untreated manure.

In one embodiment, the present invention also provides methods of maintaining levels of organic carbon in an animal manure, comprising the step of contacting said manure with an effective amount of biomass comprising bromoform.

As discussed above and demonstrated in Example 1, the methods of the present invention can be performed with manure in a system to result in treated manure from which less CH₄ has been produced from anaerobic degradation. Accordingly, the present invention provides a treated manure (e.g. ‘digestate’ produced by the methods described herein). The treated animal manure is useful for several industrial and agricultural purposes such as a fertilizer.

In one aspect the present invention relates to a method of manufacturing treated manure, said method comprising:
a. providing an animal manure and initiating an anaerobic degradation process in a system (e.g. bioreactor)
b. contacting the animal manure with an effective amount of biomass comprising bromoform under anaerobic conditions; and
c. collecting the treated manure.

In one embodiment the treated manure is used as a fertilizer. In another embodiment the method further comprises treating the treated manure to commercial grade fertilizer.

In another embodiment the present invention provides a composition comprising an effective amount of a biomass comprising bromoform, wherein the composition can be added to any anerobic system, such as rice paddies or bio-solid treatment systems (including without limitation, animal manure), which otherwise produce methane, and to other waste materials to give the waste materials useful characteristics.

The biomass comprising bromoform is contacted in a form of the biomass in which bromoform remains effective.

In another embodiment wherein the biomass further comprises one or more of dibromocholoromethane, bromochloroacetic acid, dibromoacetic acid, and/or dichloromethane. The biomass comprising bromoform is preferably contacted in a form in which the bromoform and one or more of dibromocholoromethane, bromochloroacetic acid, dibromoacetic acid, and/or dichloromethane remain effective.

Importantly, the inventors have shown that freeze dried milled Asparagopsis possess the property of reducing methane production from anaerobic degradation of animal manure comprising the step of contacting said manure with an effective amount of biomass comprising bromoform.

According to an embodiment of the invention, the biomass comprising bromoform is prepared in a manner suitable for contacting with manure.

According to an embodiment of the invention, wherein the biomass comprising bromoform is biomass of at least one species of red marine macroalgae, the biomass is freeze dried.

According to another embodiment of the invention, wherein the biomass comprising bromoform is biomass of at least one species of red marine macroalgae, the biomass is freeze dried and ground to a powder. For example, the biomass of at least one species of red marine macroalgae is freeze dried and ground through a sieve (e.g. a 1 mm sieve).

Intact freeze dried, milled biomass of Asparagopsis requires careful processing to minimize the loss of volatile bioactive compounds, such as bromoform, and maintain activity. An effective current method of preparation of biomass of Asparagopsis is to immediately freeze and subsequently freeze dry biomass for use as a feed supplement.

According to another embodiment of the invention, the biomass of at least one species of red marine macroalgae is air dried.

According to another embodiment of the invention, the biomass of at least one species of red marine macroalgae is air dried and coarsely milled.

Similarly, other biomass comprising bromoform requires careful processing to minimize the loss of the volatile bromoform, and maintain activity.

The biomass comprising bromoform may be contacted with an animal manure in one of many ways. The biomass comprising bromoform can be contacted in a solid form, may be distributed in an excipient, and directly applied to the animal manure, may be physically mixed with an animal manure in a dry form, or the biomass comprising bromoform may be formed into a solution and thereafter sprayed onto an animal manure. The biomass comprising bromoform can be contacted in a liquid form, may be distributed in an excipient, and directly applied to the animal manure, may be physically mixed with an animal manure in a liquid form, or the biomass comprising bromoform may be formed into a solution and thereafter sprayed onto an animal manure. The method of contacting of the biomass comprising bromoform to an animal manure is considered to be within the skill of the artisan.

In one embodiment the method comprises a method for reducing methane production from anaerobic degradation of animal manure comprising the step of contacting said manure with an effective amount of biomass comprising bromoform, wherein the biomass comprising bromoform is a biomass of red marine macroalgae comprising more than one species of red marine macroalgae.

For example, in one embodiment the biomass of red marine macroalgae comprises one species of red marine macroalgae selected from the group consisting of Asparagopsis armata, Asparagopsis taxiformis, Bonnemaisonia hamifera and Bonnemaisonia asparagoides.

For example, in one embodiment the biomass of red marine macroalgae comprises more than one species of red marine macroalgae selected from the group consisting of Asparagopsis armata, Asparagopsis taxiformis, Bonnemaisonia hamifera and Bonnemaisonia asparagoides.

When using more than one species the proportions can vary from less than 1% to 99%, more advantageously from 25% to 75% and even more advantageously approximately 50% for each species.

The present inventors have demonstrated that Asparagopsis biomass can effectively reduce methane production, relative to control, from anaerobic degradation of animal manure when Asparagopsis biomass is contacted with said animal manure at a level of at least 0.1% of organic matter of the manure.

The present inventors have also demonstrated that Asparagopsis biomass can effectively reduce methane production, relative to control, from anaerobic degradation of animal manure when Asparagopsis biomass is contacted with said animal manure at a level of at least 0.4 and 0.8% of organic matter of the manure. For example, FIG. 1 demonstrates that methane was undetectable with inclusion of 0.80% of organic matter.

Accordingly, in one embodiment the present invention provides a method for reducing methane production from anaerobic degradation of animal manure comprising the step of contacting said manure with an effective amount of biomass comprising bromoform, wherein said effective amount of biomass is contacted with said animal manure at a level of at least 0.1% of organic matter of the manure.

Therefore, in one embodiment, the biomass of red marine macroalgae is contacted with an animal manure at a dose of preferably at least 0.01, 0.1, 0.2, 0.3, 0.4, 0.5, 0.6, 0.7, 0.8, 0.9, or 1% of the organic matter of the animal manure.

In another embodiment, the biomass of red marine macroalgae is contacted with an animal manure at a dose of preferably at least 2, 3, 4, 5, 6, 7, 8, 9, or 10% of the organic matter of the animal manure.

In one preferred embodiment, the effective amount of biomass is contacted with said animal manure at a level of at least 0.1% of organic matter of the manure.

In another preferred embodiment, the effective amount of biomass is contacted with said animal manure at a level of at least 0.2% of organic matter of the manure.

In another preferred embodiment, the effective amount of biomass is contacted with said animal manure at a level of at least 0.4% of organic matter of the manure.

In another preferred embodiment, the effective amount of biomass is contacted with said animal manure at a level of at least 0.8% of organic matter of the manure.

In another embodiment, the biomass of red marine macroalgae is contacted with an animal manure at a dose of preferably at least 0.01, 0.1, 0.2, 0.3, 0.4, 0.5, 0.6, 0.7, 0.8, 0.9, or 1% of the dry matter of the animal manure.

In another embodiment, the biomass of red marine macroalgae is contacted with an animal manure at a dose of preferably at least 2, 3, 4, 5, 6, 7, 8, 9, or 10% of dry matter of the animal manure.

In one preferred embodiment, the effective amount of biomass is contacted with said animal manure at a level of at least 0.1% of dry matter of the manure.

In another preferred embodiment, the effective amount of biomass is contacted with said animal manure at a level of at least 0.2% of dry matter of the manure.

In another preferred embodiment, the effective amount of biomass is contacted with said animal manure at a level of at least 0.4% of dry matter of the manure.

In another preferred embodiment, the effective amount of biomass is contacted with said animal manure at a level of at least 0.8% of dry matter of the manure.

As used herein the terms, “organic matter” and “dry matter” refer to the amount of matter (on an organic or moisture-free basis, respectively) in an animal manure or including in the form of sewage sludge or septage. It is known in the art how to calculate organic matter and dry matter content of an animal manure.

To calculate the volume of biomass required to achieve a dose relative to a desired % level of the organic matter in an animal manure, the % organic matter amount of the biomass comprising bromoform (e.g. biomass of Asparagopsis) is calculated. For example, if dried Asparagopsis biomass consists of 50% organic matter (OM), and if the desired level to be contacted with an animal manure is 0.1% Asparagopsis OM in an animal manure (e.g. 100 kg of an animal manure that is 80% organic matter), then 160 g of Asparagopsis biomass consisting of 50% organic matter is required per 100 kg of an animal manure that is 80% organic matter.

Accordingly, the corresponding content of OM originating from biomass comprising bromoform can be calculated from different contents of organic matter (OM) %, or different contents of organic matter (OM) % of dry weight (dw). For example, a content of organic matter (OM) of 50%, 55%, 60%, 70%, 75% or 80% etc. of dw based on previous data can be used to calculate the corresponding content of OM originating from Asparagopsis in the biomass.

Calculations to calculate the amount of a particular biomass comprising a known amount of bromoform are described herein.

To calculate the amount of biomass comprising bromoform required to achieve a dose equivalent to a desired % level of the organic matter to be contacted with an animal manure, the % organic matter amount of the biomass comprising bromoform is calculated from the fresh weight of biomass. For example, wherein the biomass is a biomass of Asparagopsis, the fresh weight to dry weight (dw) ratio of blotted dry Asparagopsis is 10 (i.e. 30 g fw=3 g dw). Assuming a content of organic matter (OM) of 50 to 80% of dw based on previous data, the corresponding content of OM originating from Asparagopsis in the biomass can be calculated.

As used herein in relation to an animal manure the term “dry solids” (ds) or “dry weight” (dw) refers to the total solids of a manure, including an animal manure in the form of a slurry, expressed in terms of % on a dry weight basis (% wt/wt).

For example, for 100 kg of animal manure where 80% of the manure is organic matter, then the biomass comprising bromoform (wherein the biomass is 100% OM) is contacted with the animal manure at a dose of about 8, 80, 160, 240, 320, 400, 480, 560, 640, 720 or 800 grams to result in a dose at about 0.01, 0.1, 0.2, 0.3, 0.4, 0.5, 0.6, 0.7, 0.8, 0.9, or 1%, respectively, of the organic matter of the animal manure.

For example, for 100 kg of animal manure where 60% of the manure is dry matter, then the biomass comprising bromoform (wherein the biomass is 100% OM) is contacted with the animal manure at a dose of about 6, 60, 120, 180, 240, 300, 360, 420, 480, 540, or 600 grams to result in a dose at about 0.01, 0.1, 0.2, 0.3, 0.4, 0.5, 0.6, 0.7, 0.8, 0.9, or 1%, respectively, of the dry matter of the animal manure.

For example, for 100 kg of animal manure where 80% of the manure is organic matter, then the biomass of red marine macroalgae (wherein the biomass is 100% OM) is contacted with the animal manure at a dose of about 8, 80, 160, 240, 320, 400, 480, 560, 640, 720 or 800 grams to result in a dose at about 0.01, 0.1, 0.2, 0.3, 0.4, 0.5, 0.6, 0.7, 0.8, 0.9, or 1%, respectively, of the organic matter of the animal manure.

For example, for 100 kg of animal manure where 60% of the manure is dry matter, then the biomass of red marine macroalgae (wherein the biomass is 100% OM) is contacted with the animal manure at a dose of about 6, 60, 120, 180, 240, 300, 360, 420, 480, 540, or 600 grams to result in a dose at about 0.01, 0.1, 0.2, 0.3, 0.4, 0.5, 0.6, 0.7, 0.8, 0.9, or 1%, respectively, of the dry matter of the animal manure.

The “dose” or “doses” referred to herein refer to the amount of biomass to be contacted with an animal manure during a given period of contact, e.g. a day, a week or a month of contact. The biomass comprising bromoform may therefore be contacted with an animal manure (e.g. by adding a biomass comprising bromoform) at a regular interval, for example, every day, every other day, every other two days, etc., without departing from the scope of the invention.

The time period of contact is not crucial so long as the reductive effect on methane production is shown.

For example, for 100 kg of animal manure where 80% of the manure is organic matter, then the biomass comprising bromoform (wherein the biomass is 100% OM) is contacted with the animal manure at a dose of about 8, 80, 160, 240, 320, 400, 480, 560, 640, 720 or 800 grams per day to result in a dose at about 0.01, 0.1, 0.2, 0.3, 0.4, 0.5, 0.6, 0.7, 0.8, 0.9, or 1% of the organic matter, respectively, of the animal manure per day.

In one embodiment, the doses defined herein—for example—as the amount per kg of manure refer to the average amount of the biomass comprising bromoform during a given period of contact, e.g. during a day, a week or a month of contact.

The effective amount of biomass comprising bromoform can be contacted with an animal manure in one or more doses.

The effective amount of biomass comprising bromoform can also be contacted with an animal manure in one or more doses on a daily basis.

The present method may comprise administration of the biomass comprising bromoform in accordance with the above regimens for a period of at least 12, 24, 36, 48, 50, 72 hours, or 1, 2, 3, 4, 5, 6, 7, 14, 21, 28, 48, or 96 days. An aspect of the invention resides in the fact that the present methods provide effective reduction of methane over extended periods of contact.

The present study provides the first evidence that biomass comprising bromoform, such as an Asparagopsis biomass, can effectively reduce methane production when added to manure, and the present inventors have demonstrated that when contacted with manure, Asparagopsis reduced CH₄ production relative to a negative control.

For example, the present inventors have demonstrated that the amount of methane produced from anaerobic fermentation of animal manure is reduced by at least 65% with inclusion of biomass comprising bromoform at 0.20% of organic matter, compared to the amount of methane produced from control.

The present inventors have also demonstrated that the amount of methane produced from anaerobic fermentation of animal manure is reduced by at least 90% with inclusion of biomass comprising bromoform at 0.40% of organic matter, compared to the amount of methane produced from control.

The present inventors have also demonstrated that the amount of methane produced from anaerobic fermentation of animal manure is reduced to undetectable levels with inclusion of biomass comprising bromoform at 0.80% of organic matter, compared to the amount of methane produced from control.

Accordingly, in preferred embodiments of the invention, the amount of methane produced is reduced by at least 10, 20, 30, 40, 50, 60, 65, 70, 75, 80, 85, 90, or 95%, compared to a reference. In one embodiment the reference is the amount of methane produced when an animal manure is not contacted with an effective amount of at least one species of red marine macroalgae.

In one embodiment, the amount of methane produced by anaerobic fermentation in vitro is reduced by at least 96, 97, 98, 98.5 or 98.8% compared to the amount of methane produced when animal manure is not contacted with an effective amount of at least one species of red marine macroalgae.

To calculate the amount of biomass comprising bromoform required to achieve a dose of bromoform, the mass of bromoform per mass of organic matter or dry matter of the biomass comprising bromoform is determined, and a desired concentration of bromoform in the contacted animal manure is used to calculate the amount of biomass comprising bromoform required to achieve the dose of bromoform.

For example, when the biomass comprises bromoform at a level of 6.5 mg of bromoform per g DW of biomass, the biomass is 50% OM, and the desired dose or level of bromoform to be contacted with an animal manure is 26 mg of bromoform per kg of the manure dry weight, the level of inclusion of biomass is 26 mg/(6.5 mg×2)=2 mg of biomass per kg=0.0002%.

In another example, when the biomass comprises bromoform at a level of 6.5 mg of bromoform per g DW of biomass, the biomass is 50% OM, and the desired dose or level of bromoform to be contacted with an animal manure is 26 mg of bromoform per kg of the manure organic matter (and for the purposes of clarity only; assume the manure OM is 100% of DW), the level of inclusion of biomass is 26 mg/(6.5 mg×2)=2 mg of biomass per kg=0.0002%.

In another aspect the present invention also provides an additive for reducing methane production from an animal manure, said additive comprising an effective amount of a biomass comprising bromoform.

In one embodiment, the biomass comprising bromoform is at least one species of red marine macroalgae.

In one embodiment, the species of red marine macroalgae is an Asparagopsis species. In another embodiment, the species of Asparagopsis is A. taxiformis or A. armata.

In another embodiment, the present invention provides an additive for reducing methane production from anaerobic degradation of animal manure, said additive comprising an effective amount of a biomass comprising bromoform. In one embodiment, the biomass comprising bromoform is a biomass of red marine macroalgae, for example, wherein the red marine macroalgae is an Asparagopsis species and/or a Bonnemaisonia species. In one embodiment of the additive, the species is selected from Asparagopsis armata Asparagopsis taxiformis, Bonnemaisonia hamifera and Bonnemaisonia asparagoides.

As used herein, the term “additive” refers to a concentrated additive premix comprising the active ingredients (e.g. biomass comprising bromoform), which may be added to an animal manure. Typically, the additive of the present invention is in the form of a powder or compacted or granulated solid. In another embodiment, the additive of the present invention is in the form of a liquid. For example, the additive of the present invention is in the form of a liquid in which the biomass is present in or extracted into a liquid, such as an oil. The invention is not particularly limited in this respect.

In one embodiment, an additive according to the invention is contacted with an animal manure at a dose as calculated herein.

It is within the skills of the trained professional to determine exactly the ideal amounts of the components to be included in the additive and the amounts of the additive to be used in contacting with an animal manure, etc. Preferred dosages of each of the components, including biomass comprising bromoform, are described herein.

For example, in one embodiment, the additive comprises said effective amount of biomass formulated for contact with said animal manure at a level of at least 0.1% of organic matter of the manure. In another embodiment, said effective amount of biomass is formulated for contact with said animal manure at a level of at least 0.2% of organic matter of the manure. In another embodiment, said effective amount of biomass is formulated for contact with said animal manure at a level of at least 0.4% of organic matter of the manure. In another embodiment, said effective amount of biomass is formulated for contact with said animal manure at a level of at least 0.8% of organic matter of the manure.

The additive of the present invention may comprise any further ingredient without departing from the scope of the invention. It may typically comprise well-known excipients that are necessary to prepare the desired product form and it may comprise further additives aimed at improving a characteristic of the animal manure, such as the quality of an animal manure.

In another embodiment, the additive is used to contact a monogastric animal manure. In another embodiment, the monogastric animal is selected from the members of the Suina suborder. In a preferred embodiment, the animal is a swine.

In another embodiment, the additive is used to contact a ruminant animal manure. In another embodiment, the ruminant animal is selected from the members of the Ruminantia and Tylopoda suborders. In a preferred embodiment, the ruminant animal is a cattle or sheep.

In another aspect the present invention provides a method for reducing methane production from anaerobic degradation of animal manure comprising the step of contacting said manure with an effective amount of an additive as described herein.

The present inventors have demonstrated anaerobic degradation of animal manure in contact with an effective amount of a biomass comprising bromoform in a system comprising a reactor vessel (e.g. Example 1).

Accordingly, in another aspect, the present invention provides a system for the digestion of an animal manure.

In another aspect, the present invention provides a system for the anaerobic digestion of an animal manure.

In another embodiment, the system comprises a bioreactor or digester.

In one embodiment, an animal manure is the substrate for digestion in a system for the digestion of an animal manure, and the manure comprises the components (including macro and micro nutrients) required for anaerobic degradation.

In one embodiment, an animal manure is the substrate for digestion in a system for the digestion of an animal manure, and the manure comprises the components (including macro and micro nutrients) required for anaerobic methanogenesis.

In one embodiment, an animal manure is the substrate for digestion in a system for the digestion of an animal manure, and the manure comprises the components (including macro and micro nutrients) required for microbial growth.

The manure can be used in (e.g. fed into) the system (e.g. bioreactor) repeatedly during the degradation process, such as once, twice, or three times a day.

In one embodiment, the system comprises the use of at least one anaerobic fermentative organism, such as methanogenic microorganism, for the anaerobic digestion of an animal manure.

In one embodiment, the at least one anaerobic fermentative organism is provided in the animal manure fed into the system.

In another embodiment, the at least one anaerobic fermentative organism is provided in an anaerobic inoculum fed into the system.

In another embodiment, the at least one anaerobic fermentative organism is provided in the system into which the animal manure is fed, for example, in an anaerobic sludge present in the system into which the animal manure is fed.

In one embodiment, the system is maintained at a temperature permissive of methanogenesis, such as a psychrophilic (15 to 25° C.), mesophilic (30 to 38° C.), and thermophilic (50 to 60° C.), temperature. As discussed above, these temperatures/temperature ranges facilitate the growth of specific microbes.

In one embodiment the pH of the system is maintained at a pH permissive of anaerobic degradation.

In one embodiment the pH of the system is maintained at a pH permissive of methanogenesis.

For example, in one embodiment, the pH in the system is maintained below 8.3. In another embodiment, the pH in the system is maintained below 8.0.

In one embodiment, the system comprises a reactor vessel. In one embodiment the reactor vessel is a chamber to allow anaerobic degradation of an animal manure in contact with a biomass comprising bromoform.

In one embodiment, the system comprises an inlet for addition of manure and a chamber to allow anaerobic degradation of an animal manure in contact with a biomass comprising bromoform.

In another embodiment, the bioreactor comprises an outlet for treated manure.

In another embodiment, the bioreactor comprises an outlet for gas produced in the bioreactor.

In one embodiment the present invention provides a treated manure produced by the methods and/or the systems described herein.

The invention will now be further described by way of Examples, which are meant to serve to assist one of ordinary skill in the art in carrying out the invention and are not intended in any way to limit the scope of the invention.

### EXAMPLE 1

### Contacting Biomass Comprising Bromoform with Manure In Vitro Significantly Reduces Methane Production

Asparagopsis was used as an example of biomass comprising bromoform (see Example 2), to examine the effect of biomass containing biomass on biogas production from animal manure.

The red seaweed Asparagopsis taxiformis in the filamentous gametophyte phase was collected from a site near Humpy Island, Keppel Bay, Qld (23o13′01″S, 150o54′01″E) by MACRO (Center for Macroalgal Resources and Biotechnology) of James Cook University (JCU) in Townsville, QLD. The collected biomass was frozen and stored at −15° C. then shipped to Forager Food Co. (Red Hills, TAS), where it was freeze dried to approximately 95% dry matter to retain volatile bioactive compounds. The dried Asparagopsis biomass consisting of 50% OM was milled (2-3 mm) to ensure a uniform product.

The biomass was added directly to fresh manure collected from the rectum of grain fed feedlot cattle at rates of approximately 0.0, 0.20, 0.40, and 0.80% of the manure organic matter. As shown in Example 2, the Asparagopsis taxiformis biomass contained approximately 6.5 mg of bromoform per g DW of Asparagopsis. Therefore, when added at 0.2% OM of the manure organic matter, 4 grams of biomass is added per kg of manure organic matter. Similarly, when biomass was added directly to fresh manure collected from the rectum of grain fed feedlot cattle at rates of approximately 0.0, 0.20, 0.40, and 0.80% of the manure organic matter; 0, 26 mg, 52 mg, and 104 mg of bromoform is therefore added per kg of manure organic matter, respectively.

The manure and seaweed mixtures were combined with Goering and van Soest (1970) buffer (GVB) at a ratio of 1:4 (manure:GVB v/v). The full system was N₂ purged and a Dose-It pump (Integra Biosciences, Hudson, N.H., USA) was used to aspirate 100 mL of GVB into incubation bottles containing the Asparagopsis and 50 mL of fresh manure. The bottles were sealed with an Ankom RF1 gas production module (Macedon, N.Y., USA) and placed in an incubator (Ratek OM11; Boronia, Vic., Australia) maintained at 39° C. and oscillating at 85 RPM.

To characterise the effect of biomass comprising bromoform on methane production from manure an incubation session was conducted using three Asparagopsis inclusion rates of 0.20, 0.40, and 0.80% of the manure dry matter and compared with a control (no macroalgae) and GVB blanks. Each inclusion level and Controls were characterised using six incubation units consisting of manure from six different cattle representing each sampling time point (24, 48, and 72 h). Controls and blanks were included at all time points. The data was then combined to provide time series curves covering the full 72 h.

In vitro CH₄ production was determined and time series production curves prepared by collection of samples at multiple time points. Production of methane from manure was estimated by application of CH₄ concentration in time series samples while assuming constant homogeneity of bottle headspace. Concentration of CH₄ in headspace collected in 10-mL Labco Exetainer vacuum vials (Lampeter, Great Britain) were measured by gas chromatography (GC) on a Shimadzu GC-2014 (Kyoto, Japan) equipped with a Restek (Bellefonte, Pa., USA) ShinCarbon ST 100/120 column (2 m·1 mm·micropacked) with a flame ionisation detector (FID). Column temperature was 150° C., injector was 24° C., and 380° C. in the FID. Ultra high purity N₂ was the carrier gas at 25 mL/min and injection volume was 250 mL.

The results of the gas sample analysis were collated. FIG. 1 shows methane emissions over 72 hours of incubation.

With increasing inclusion of biomass comprising bromoform, the average amount of methane emitted from the manure of six different cattle decreased significantly. The decrease was especially potent at inclusion levels of 0.40 and 0.80% of DM. Methane was undetectable with inclusion of 0.80% and manure from only two cows produced nominal but detectable methane at 0.40% of manure DM after 72 hours of incubation.

These results indicate that methane production from anaerobic fermentation of manure is reduced by contacting the manure with a biomass comprising bromoform at an inclusion rate of 0.20%, 0.40% and 0.8% of manure organic matter. Importantly, these results indicate that methane production in vitro is reduced by contacting the manure with Asparagopsis.

### EXAMPLE 2

### Halogenated Metabolites in Asparagopsis taxiformis and Asparagopsis armata

The levels of bromoform, were examined in Asparagopsis spp. Asparagopsis armata was collected from Cloudy Bay, Bruny Island, Tasmania, 43°.43′94″ S; 147°.21′.52″ E.

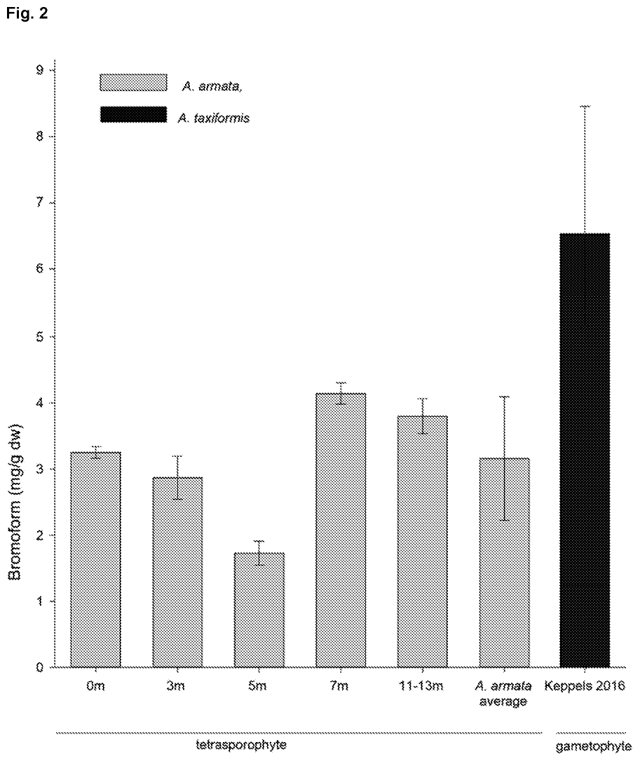

FIG. 2 demonstrates biomass of wild Asparagopsis taxiformis in the benthic gametophyte phase collected from a site near Humpy Island, Keppel Bay contains the halogenated metabolite bromoform, and that Asparagopsis taxiformis and Asparagopsis armata contain similar levels of bromoform.

1. A method for reducing methane production from anaerobic degradation of animal manure comprising the step of contacting said manure with an effective amount of biomass comprising bromoform.

2. A method according to claim 1 wherein the biomass comprising bromoform is a biomass of red marine macroalgae.

3. A method according to claim 2 wherein the red marine macroalgae is an Asparagopsis species or a Bonnemaisonia species.

4. The method of claim 2, wherein the red marine macroalgae is selected from the group consisting of Asparagopsis taxiformis, Bonnemaisonia hamifera and Bonnemaisonia asparagoides.

5. The method according to claim 1 wherein the animal manure is a ruminant animal manure or a monogastric animal manure.

6. The method of claim 1 wherein said effective amount of biomass is contacted with said animal manure at a level of at least 0.1%, at least 0.2%, at least 0.4%, or at least 0.8% of organic matter of the manure.

7. (canceled)

8. (canceled)

9. (canceled)

10. The method of claim 1, wherein the animal manure is from an animal selected from the members of the Suina, Ruminantia and Tylopoda suborders.

11. The method of claim 10, wherein said animal is a swine, cattle or sheep.

12. An additive for reducing methane production from anaerobic degradation of animal manure, said additive comprising an effective amount of a biomass comprising bromoform.

13. The additive according to claim 12, wherein the biomass comprising bromoform is a biomass of red marine macroalgae.

14. The additive according to claim 12, wherein the red marine macroalgae is an Asparagopsis species or a Bonnemaisonia species.

15. The additive according to claim 14, wherein the Asparagopsis species is Asparagopsis taxiformis or Asparagopsis armata.

16. The additive according to claim 12, wherein the animal manure is a ruminant animal manure or a monogastric animal manure.

17. The additive according to claim 12, wherein said effective amount of biomass is formulated for contact with said animal manure at a level of at least 0.1%, at least 0.2%, at least 0.4%, or at least 0.8% of organic matter of the manure.

18. (canceled)

19. (canceled)

20. (canceled)

21. The additive according to claim 12, wherein said animal is selected from the members of the Suina, Ruminantia and Tylopoda suborders.

22. The additive according to claim 21, wherein said animal is a swine, cattle or sheep.

23. A method for reducing methane production from anaerobic degradation of animal manure comprising the step of contacting said manure with an effective amount of an additive according to claim 12.

24. A method for anaerobic degradation of animal manure comprising the step of contacting said manure with an effective amount of biomass comprising bromoform.

25. A method according to claim 24 comprising initiating anaerobic degradation of animal manure in a system comprising a reactor vessel.

26. A system when used for a method of claim 1.
